(19) United States
(12) Patent Application Publication
(10) Pub. No.: US 2023/0063097 A1
(43) Pub. Date: Mar. 2, 2023

(54) Electrical driving mechanism for sonic flying devices

(71) Applicant: VIETTEL GROUP, Ha Noi City (VN)

(72) Inventors: VAN DINH PHAM, Ha Noi City (VN); KIM BAO LE, Song Lo District (VN); ANH TUAN CAO, Ha Noi City (VN); QUOC TOAN TRAN, Than Uyen District (VN); DUY TUNG NGUYEN, Ha Noi City (VN); PHAM TUAN NGUYEN, Ha Noi City (VN)

(73) Assignee: VIETTEL GROUP, Ha Noi City (VN)

(21) Appl. No.: 17/882,404

(22) Filed: Aug. 5, 2022

(30) Foreign Application Priority Data
Aug. 27, 2021 (VN) 1-2021-05295

(51) Int. Cl. B64C 39/02

(52) U.S. Cl. CPC B64C 39/024; B64C 2201/04

(57) ABSTRACT

The invention describes the electrical driving mechanism for sonic flying device in, on small airplane, UAV, Aerial observation equipment, includes: electric actuator, the first rotary shaft, the second rotary shaft, piston, cylinder cover, spring, fin, pin. The electric actuator are composed of three main parts including speed reducing gearbox, ball screw, motor, cover. The speed reducing gearbox is composed of spur gears and planetary gears. The electric actuator has small size, can be operated in high temperature, has water resistance, vibration resistance, big load, high speed, is suitable for sonic flying device and meets with working conditions.

### FIELD OF INVENTION

The invention relates to the electrical driving mechanism for sonic flying devices. In particular, the integrated driving mechanism of this invention can be applied to flying devices such as sonic flight devices, Aerial observation equipment, Unmanned aerial vehicles (UAV).

### DESCRIPTION OF RELATED ART

In recently years, along with the development of the flying devices, UAV, the driving mechanism is an indispensable device, it ensures for the flying equipment to travel in the right direction and maintains the stability and balance in the automatic flying process. For the aeronautic field, especially, aerospace equipment is high required to employ driving mechanisms having small size, light weight, high performance, big load, easy control, high reliability, and suitability for use in harsh operation conditions.

Generally, there are some kinds of the driving mechanism for nonic flying devices but each type of actuator has advantages and disadvantages as following:

Pneumatic actuator type mechanism have complicated structure including the high pressure compressed air pipeline system, pressure vessel, control valve system. Due to high force requirement, a pneumatic actuator requires the pressure vessel. The working principle of pneumatic actuator is suppling high pressure to generate force on the piston. Hence, the pneumatic actuator has some disadvantages such as leakage on pipeline, and can be difficult to operate due to sensitivity to dust.

Hydraulic actuator structure includes cylinder, hydraulic pipeline system, hydraulic oil, hydraulic pump. Operating principle of the hydraulic actuator is high pressure oil acting to cylinder to generate the movement to control the driving mechanisms. The hydraulic actuator also has some disadvantages such as risk of leakage, complex structure.

To improve the weakness of previous designs, the authors provide a new mechanism with electrical driving mechanism applied for sonic flying devices.

### TECHNICAL ESSENCE OF THE INVENTION

The purpose of invention is to provide an electrical driving mechanism for sonic flying devices with small size, light weight, high performance, big load, fast response, high reliability and suitability for use in harsh operation conditions. The electrical driving mechanism for sonic flying devices can combine with high speed, small size transmission.

This mechanism uses spur gear transmission combined with a planetary gear transmission and ball screw to convert rotary motion into linear motion. The system is integrated with a closed-loop feedback sensor to increase accuracy. The electrical driving mechanism for sonic flying mechanism includes:

The electric actuator (1) is the power source that controls the aerial vehicle wings (7), it receives control signals from the center control device and executes the commands;

The first rotary shaft (2) and second rotary shaft (6) are fixed with rotary center at D and E, they are linked to the electric actuator (1) and piston (3) by pins (8), these pins (8) are made of steel, alloy steel, aluminum, alloy aluminum and are assembled on shell body at D and E rotary center.

Piston (3) is assembled with cylinder cover (5) and is attached with spring (4) to anti-overload and force transmission from electric actuator (1) into control fin (7);

The spring (4) can be coil spring or disk spring, it is assembled in the middle of piston (3) to transmit force from electric actuator (1) into control fin (7) and anti-overload.

Cylinder cover (5) is assembled with piston (3), can adjust the length and it has flange to limit spring travel.

The control fin (7) is at the end of executive structure, it is designed to be suitable with flying vehicles.

In this invention, electric actuator (1) receives the commands from controller center, the screw nut connecting shaft (1.20) of electric actuator moves to push the first rotary shaft (2) making it rotate around D, the force is transmitted into the control fin (7) through spring mechanism and the second rotary shaft (6). In case of holding position, excessive force from the control fin (7) acting suddenly on the driving mechanism, the spring system has anti-overload effect to protect the driving mechanism.

In this invention, the integration driving mechanism has small size, easy assembly and integration due to be modularized, convenient repair, maintenance and replacement. This mechanism can be operate in hard condition with temperature from −30° C. to 120° C., has vibration resistance, water resistance, and suitability for high humidity environment.

In this convention, the sonic flying device is flight device that has speed over mach one.

### DESCRIPTION OF THE DRAWINGS

FIG. 1 describes the electrical driving mechanism for sonic flying device;

FIG. 2 describes the vertical cross-section through the actuator center;

FIG. 3 describes the side view of the electric actuator;

FIG. 4 describes the side view of cross-section A-A in FIG. 2;

FIG. 5 describes the side view of cross-section B-B in FIG. 2.

### DETAILED DESCRIPTION OF THE INVENTION

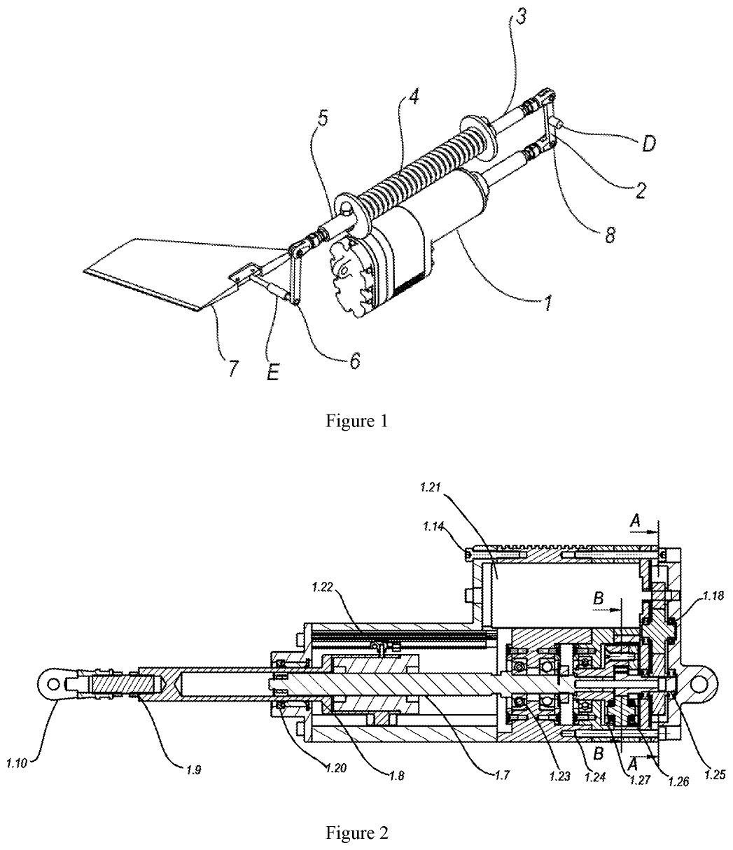

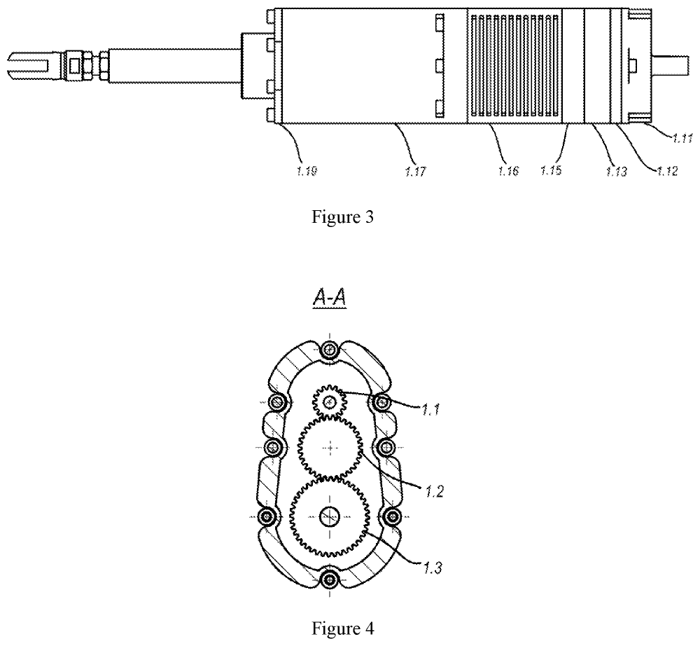

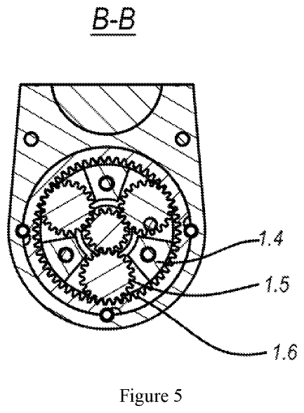

Referred to FIG. 1 to FIG. 5, the basic construction of this invention includes parts and are assembled together as follow:

The electric actuator (1) is a power source to control driving fins (7), it receives the commands from control center to control the fin. The first rotary shaft (2) and the second rotary shaft (6) are fixed with the flying device at the rotary center D and E. The rotary shafts are linked with the electric actuator (1) and the piston (3) by the pin (8); the piston (3) slides inside the spring (4) and cylinder cover (5). The pulling and pushing forces of piston (3) are converted into elastic force of spring (4), then transferred to cylinder cover (5). Reversely, the pulling and pushing forces of cylinder cover (5) are converted into elastic force of spring (4), then transferred to piston (3). The spring (4) works as the damping element in the system to prevent overload. Torque flow of the electric actuator (1) includes motor (1.21), gearbox and screw shaft-screw nut sets. Gearbox is a combination of spur gear sets and planet gear sets. The detail structure of electric actuator is as following:

Driving gear (1.1) is spur gear connected directly with motor (1.21). Intermediate gear (1.2) is assembled on the gearbox cover (1.11) and gearbox frame (1.12) through intermediate shaft bearing (1.18). Driven gear (1.3) is attached directly to main shaft (1.25) which is assembled on the gearbox cover (1.11) and gearbox frame (1.12).

Sun gear (1.4) is assembled tightly to the main shaft (1.25). Planet gears (1.5) are assembled between first carrier (1.26) and second carrier (1.27). Ring gear (1.6) is fixed with gearbox body (1.13) by inserted pins from outside. Driving screw (1.7) is multi section shaft connected with second carrier (1.27) and screw nut (1.8) to convert rotation of second carrier (1.27) into displacement of screw nut (1.8). Screw nut connecting shaft (1.20) is multi hollow-section shaft which is connected with screw nut (1.8) and intermediate shaft (1.9). The hollow section of screw nut connecting shaft (1.20) offers the space for the driving screw (1.7) going inside. A position sensor (1.22) is inserted on the frame to monitor the travel of screw nut connecting shaft (1.20). Intermediate shaft (1.9) connects screw nut connecting shaft (1.20) to clevis (1.10) and gives the connecting length adjustment ability by thread surface and bolts.

Gearbox cover (1.11) combines locating ears to be assembled to the aerial vehicle body and inner hubs for the bearing of driving gear (1.1), intermediate gear (1.2) and driven gear (1.3). Gearbox cover (1.11) is attached to gear box frame (1.12) to create space for spur gear set. The other side of gear box frame (1.12) is combined with gear box body (1.13) and gear box base (1.15) to make a frame and space for planet gear set. The sun gear (1.4) is attached to main shaft (1.25) which is held on a couple of bearing in the gear box cover (1.11) and gear box frame (1.12). The inner side of main body (1.16) includes hubs for driving screw bearing, motor (1.21) and hole thread for fasteners to assemble with main frame (1.17) and gear box base (1.15). The outer side of main body (1.16) is designed with multi air-cooling blades to increase the thermal transferring ability.

Motor (1.21) torque is transferred through driving gear (1.1), intermediate gear (1.2), driven gear (1.3) to the main shaft (1.25), then goes to the sun gear (1.4), planet gear (1.5), the first carrier (1.26) and second carrier (1.27), continuously to the driving screw (1.7) and screw nut (1.8), and is converted to displacement of screw nut (1.8), screw nut connecting shaft (1.20), intermediate shaft (1.9) and clevis (1.10).

### POSSIBLE EFFECT OF THE INVENTION

The inventions relates to the electrical driving mechanism for sonic flying devices. Particularly, the integrated driving mechanism mentioned in this convention can be applied for flying devices such as sonic flight device, aerial observation equipment, unmanned aerial vehicle (UAV).

The electrical driving mechanism can be used for sonic flying devices can be operated at temperature of −30±100° C. and performs low power consumption, waterproof IP68, high stability. Its vibration resistance meets MIL-STD-810G standard.

1. An electric actuator pulls and pushes one end of a rotary shaft rotating around at a turning point and another end of the rotary shaft pulls and pushes a piston;
a turning point of the rotary shaft is constrained five degrees of freedom with a body of an aerial vehicle;
The piston slides inside the a cylinder cover, transfers pulling and pushing force to a cylinder cover through a spring having ends;
The piston and cylinder cover are put inside the spring;
The spring ends are fixed with the piston and the cylinder cover;
The Cylinder cover pulls and pushes one end of a second rotary shaft to rotate it around a turning point which is concentric with a shaft of the aerial vehicle fin and is constrained five degrees of freedom with the body of aerial vehicle.

2. An electric actuator combines an electric motor, a gear box and a set of a screw shaft and screw nut;
The gearbox includes a spur gear set and a planet gear set;
The spur gear set combines a driving gear connected directly to an motor output shaft, an intermediate gear and a driven gear;
The driven gear is assembled with a shaft of sun gear of the planet gear set;
a ring gear of the planet gear set is fixed with a gearbox cover by an inserted pin;
a carrier of the planet gear set is fixed with the screw shaft;
The screw nut is put inside a screw nut connecting shaft which has a hollow form;
The screw shaft goes into a hole of the screw nut connecting shaft;
a position sensor is fixed on a main frame of the electric actuator.
